(19) United States
(12) Patent Application Publication
(10) Pub. No.: US 2010/0302269 A1
(43) Pub. Date: Dec. 2, 2010

(54) IMAGE PROCESSING APPARATUS AND IMAGE PROCESSING METHOD

(75) Inventor: Masami MORIMOTO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/712,342

(22) Filed: Feb. 25, 2010

(30) Foreign Application Priority Data
May 26, 2009 (JP) P2009-126563

(51) Int. Cl. G09G 5/02

(52) U.S. Cl. 345/589; 345/690

(57) ABSTRACT

Saturation information and luminance information are obtained from each pixel included in a frame, and thereafter histogram information corresponding to luminance information is generated by summering weighting coefficient, wherein weighting coefficient is obtained in accordance with the saturation information. The maximum luminance is determined based on the histogram information, and thereafter a brightness of a backlight is determined based on a display ability of a display unit and the maximum luminance. Then, gradation of an input image is converted based on the maximum luminance.

### BACKGROUND

1. Technical Field

The present invention relates to an image processing apparatus which performs correction of an image to be displayed on a display unit.

2. Related Art

For example, JP-A-2007-249085 discloses that an image processing apparatus, which is used with a display device that uses a display panel such as a liquid crystal display (LCD), maintains the visual brightness of an image by reducing brightness of a backlight. When displaying a dark scene, the brightness of the backlight is reduced from a brightness of the backlight set when a bright scene is displayed. Therefore, gradations are corrected in accordance with the brightness of the backlight, and thus color reproducibility of the dark scene is improved. Specifically, in the dark scene, the leakage of light from a backlight is reduced in accordance with the reduction of the brightness of the backlight, accordingly contrast is improved along with reduction of black floating and color formation is improved along with increase of the color purity.

However, if there are pixels with high gradation, such as fireworks, in the entirely dark scene, white out may occur with respect to high-gradation pixels. Namely, the pixels with high-gradation pixels are whitened because of no differences among R, G, and B. Due to this, the color formation of light points, e.g. fireworks, deteriorates.

### SUMMARY

Exemplary embodiments of the invention provides an image processing apparatus that includes a saturation extraction unit which obtains saturation information from each pixel included in a frame, a luminance extraction unit which obtains luminance information of the each pixel, a histogram generation unit which generates histogram information corresponding to luminance information by summering weighting coefficient, wherein a larger weighting coefficient is assigned to a lower saturation, a determining unit which determines the maximum luminance and determines a brightness of a backlight based on a display ability of a display unit and the maximum luminance, and a gradation conversion unit which converts a gradation of an input image.

### BRIEF DESCRIPTION OF THE DRAWINGS

FIG. 1 is a circuit block diagram illustrating a configuration of an image processing apparatus;

FIG. 2 shows an example of relationship between saturation and weighting coefficient;

FIG. 3 shows an example of histogram; and

FIG. 4 shows an example of a gradation conversion table.

### DETAILED DESCRIPTION

Hereinafter, with reference to the accompanying drawings, exemplary embodiments of the present invention will be described.

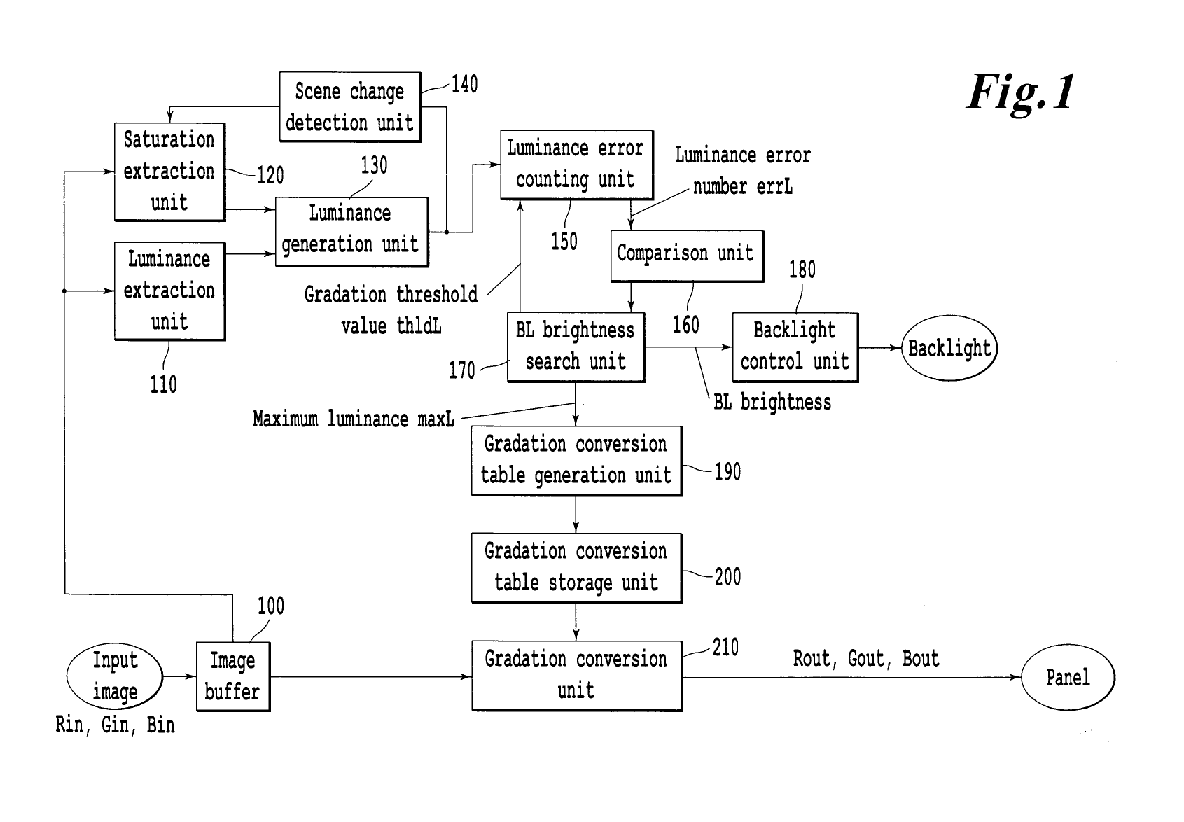

FIG. 1 is a diagram illustrating a configuration of an image processing apparatus. The image processing apparatus may be an integrated circuit for processing image data and may be equipped in a mobile communication apparatus such as a cellular phone. The image processing apparatus includes an image buffer 100, a luminance extraction unit 110, a saturation extraction unit 120, a luminance histogram generation unit 130, a scene change detection unit 140, a luminance error counting unit 150, a comparison unit 160, a BL (backlight) brightness search unit 170, a backlight control unit 180, a gradation conversion table generation unit 190, a gradation conversion table storage unit 200, and a gradation conversion unit 210.

The image buffer 100 buffers input image data RGBin for each frame. The image data RGBin in the image buffer 100 is read by the brightness extraction unit 110, the saturation extraction unit 120, and the gradation conversion unit 210.

The luminance extraction unit 110 reads one frame of the input image data RGBin from the image buffer 100, and obtains the luminance L of each pixel from RGB (Red, Green, and Blue) values Rin, Gin, and Bin of each pixel. Subsequently, the luminance extraction unit 100 determines the maximum value MAX from the respective RGB values Rin, Gin, and Bin of each pixel based on the following criterion. In this criterion, one of the RGB values having the maximum luminance level L is determined as the maximum value MAX.

$$MAX = \{ \begin{matrix}Rin & ( Rin > Gin , Rin > Bin ) \\ Gin & ( Gin > Rin , Gin > Bin ) \\ Bin & ( Bin > Rin , Bin > Gin )\end{matrix} \\ L = MAX$$

The criterion described above may be expressed by following equation. In this equation, one of Rin, Gin, and Bin having the maximum luminance level L is determined as the maximum value MAX.

MAX=max(Rin,Gin,Bin)

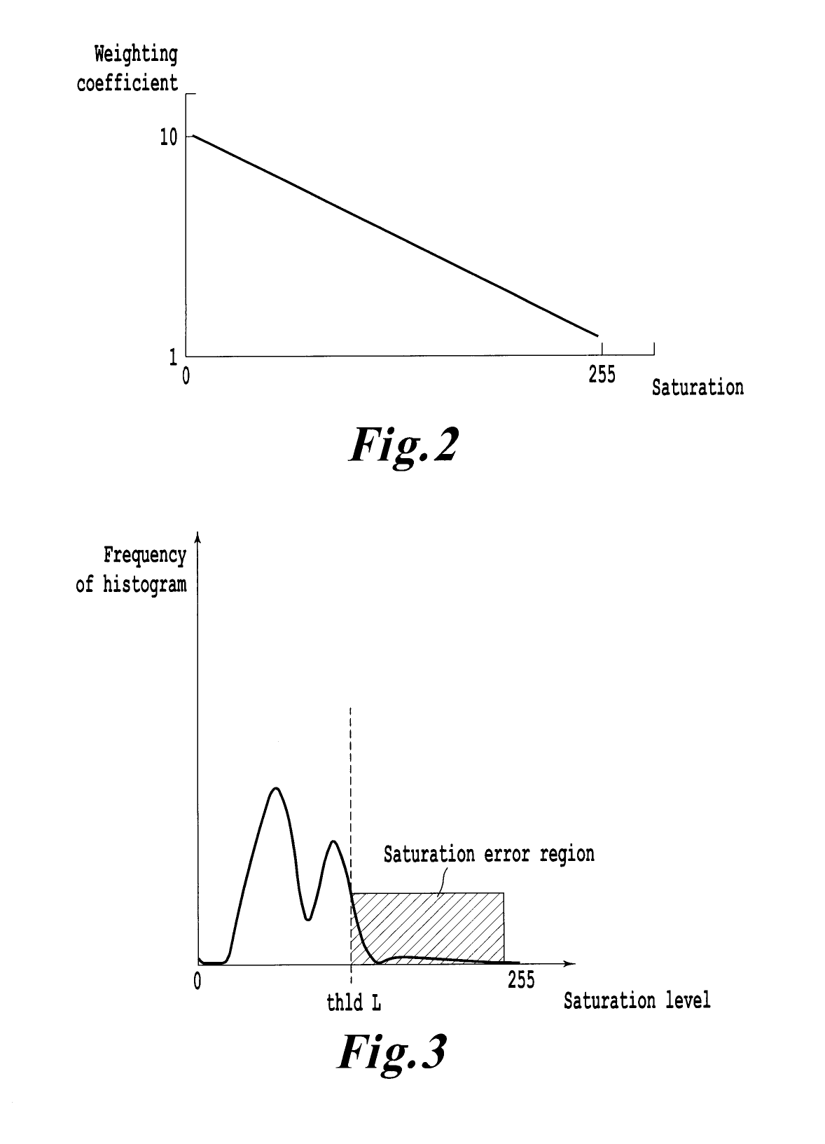

If the scene change detection unit 140 detects that a scene change has occurred, the saturation extraction unit 120 obtains the saturation S for each pixel from the RGB values Rin, Gin, and Bin of each pixel, and obtains a weighting coefficient W for each pixel based on the saturation S of each pixel in accordance with the characteristics as shown in FIG. 2. However, if the saturation S is 0, the weighting coefficient W becomes 0. For example, the saturation S and the weighting coefficient W are obtained based on the following criterion. Here, lower saturation S indicates fainter color.

$$MIN = \{ \begin{matrix}Rin & ( Rin < Gin , Rin < Bin ) \\ Gin & ( Gin < Rin , Gin < Bin ) \\ Bin & ( Bin < Rin , Bin < Gin )\end{matrix} \\ S = 255 * ( MAX - MIN ) / MAX \\ W = [ ( 255 - S ) / 255 ] * 10$$

Also, the criterion described above may be expressed as MIN=min(Rin, Gin, Bin) as well.

The weighting coefficient W may be obtained from the following equation by using the luminance level L obtained by the luminance extraction unit 110.

W=[(255−S)/255]*10*1/log L

When the input image is a moving image, the moving image is typically encoded in a YUV form. In this case, the saturation S of each pixel may be obtained in a YUV form immediately after the input image is decoded. In the case of the YUV, the saturation S is obtained based on the following equation by using the size of a UV vector.

S=SQRT(U²+V²)

The luminance generation unit 130 generates a luminance histogram histoL for each frame, as shown in FIG. 3, based on the luminance level L for each pixel obtained by the luminance extraction unit 110 and the weighting coefficient W obtained by the saturation extraction unit 120. That is, when the luminance histogram generation unit 130 receives the luminance level L of each pixel in a frame, as shown in the following equation, the luminance histogram generation unit 130 adds the weighting coefficient W which corresponds to the saturation S of the pixel to a frequency of the luminance level L corresponding to the luminance histogram histoL. By performing this operation with respect to all of the pixels in a frame, the luminance histogram histoL is generated. In this case, if the scene change determination unit 140 determines that no scene change has occurred, the saturation extraction unit 120 does not calculate the weighting coefficient W, and thus the weighting is not performed.

histoL[L]+=W(L=0, . . . , 255)

The scene change determination unit 140 compares the luminance histograms histoL obtained with respect to a plurality of frames, and determines whether the scene change has occurred by determining whether a difference SAD (Sum of Absolute Differences) between the obtained luminance histograms histoL exceeds a threshold value. If the scene change has occurred, the scene change determination unit 140 reports the occurrence of the scene change to the saturation extraction unit 120. In this case, the difference SAD is obtained, for example, based on the following equation. That is, the differences between the luminance histogram histoL of the frame to be processed and the luminance histogram histoL_prey of the previous frame are obtained for the Luminance of each pixel, and the obtained differences are sums up.

SAD=Σ:histoL[x]−histoL_prev[x]:(x=0, . . . , 255)

The luminance error counting unit 150, based on the searched gradation threshold value thldL given from the BL brightness search unit 170 to be described later and the luminance histogram histoL obtained by the luminance histogram generation unit 130, obtains a frequency by counting the number of times that the luminance histogram histoL is equal to or more than a gradation threshold value thldL in accordance with the following equation, and then outputs the frequency as the luminance error number ErrL.

ErrL=ΣhistoL[x] (x=thldL, . . . , 255)

The comparison unit 160 determines whether the luminance error number ErrL is larger than the luminance error number threshold value ErrThld by comparing the luminance error number ErrL obtained by the luminance error counting unit 150 with the preset luminance error number threshold value ErrThld. Here, if the luminance error number ErrL is larger than the luminance error number threshold value ErrThld, “1” is output as the result of determination, while if the luminance error number ErrL is equal to or smaller than the luminance error number threshold value ErrThld, “0” is output as the result of determination.

Here, the luminance error number threshold value ErrThld is a value set according to the balance between the picture quality of a bright region and the picture quality of a dark region. For example, if the luminance error number threshold value ErrThld is set to a small value, the gradation of the bright region can be maintained, while if the luminance error number threshold value ErrThld is set to a large value, low power consumption and improvement of the gradation of the dark region and the color representation can be expected. Consequently, the luminance error number threshold value ErrThld is predetermined depending upon which one out of picture quality and power consumption is more considerable. On the other hand, since image typically includes a noise, the luminance error number threshold value ErrThld should not be “0”, but should be set, for example, to about 10% of the total number of pixels.

The BL brightness search unit 170 sets the gradation threshold value thldL to the luminance error counting unit 150. The initial value of the gradation threshold value thldL is The BL brightness search unit 170 repeats the setting of the gradation threshold value thldL to the luminance error counting unit 150 until the output from the comparison unit 160 becomes “1” by decreasing the gradation threshold search value by 1. Consequently, when the output of the determination output from the comparison unit 160 becomes “1”, the BL brightness search unit 170, as the maximum luminance maxL, outputs the gradation threshold search value thldL, set to the luminance error counting unit 150 when the comparison unit 160 outputs “1”, to the gradation conversion table generation unit 190.

Then, the BL brightness search unit 170 determines the brightness value BL of the backlight of the display based on the maximum luminance maxL, and outputs the brightness value BL to the backlight control unit 180. The brightness value BL is obtained in the following equation. In this equation, the term “BLmax” is the maximum brightness value of the backlight of the display. Also, γ is the characteristic of the display panel.

BL=BLmax*(maxL/255)^{̂γ}

Generally, γ of the panel is set to 2.2 in accordance with the characteristic of a Braun tube, and in the case that the white gradation is half the maximum gradation, maxL/255 is equal to 0.5. Therefore, (maxL/255)^{̂γ} in the above equation becomes 0.5^{̂}2.2=0.22. Accordingly, the backlight brightness becomes 0.22 times value of the maximum brightness, and the brightness value BL is obtained in the following equation.

BL=BLmax*0.22

The backlight control unit 180 controls the brightness of the backlight of the display based on the brightness value BL output from the BL brightness search unit 170.

The gradation conversion table generation unit 190 generates the gradation conversion table LUT (look-up table) based on the maximum luminance maxL in order to maintain the brightness of the displayed image before and after the backlight brightness is changed. This gradation conversion table LUT is stored in the gradation conversion table storage unit 200.

Specifically, the gradation conversion table generation unit 190 obtains a gain gainL as follows using a reciprocal of the maximum luminance maxL as an extension amount of image data.

gainL=255/maxL

Then, the gradation conversion table generation unit 190 generates the gradation conversion table LUT so that a value obtained by multiplying an input x of the gradation conversion unit 210 by the gain gainL is output.

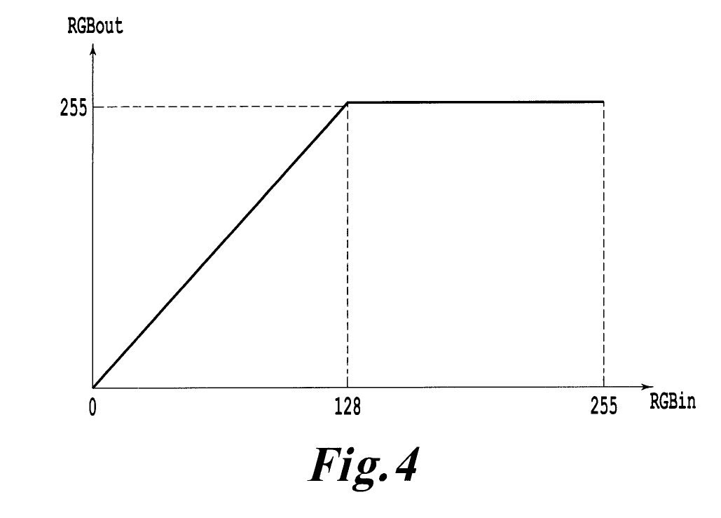

For example, if it is assumed that the maximum luminance maxL is 128, the gain gainL becomes gainL=2, and thus the gradation conversion table generation unit 190, as shown in FIG. 4 and following equation, generates the gradation conversion table LUT in which RGB values of the input image data with 128 or more become 255 at maximum.

$$LUT [ x ] = \{ \begin{matrix}x * gain L ( x * gain L ≦ 255 ) \\ 255 ( x * gain L > 255 )\end{matrix}$$

The gradation conversion unit 210 reads out the input image data RGBin from the image buffer 100 and converts the pixel values, based on the following equation, using the gradation conversion table LUT stored in the gradation conversion table storage unit 200.

Rout=LUT[Rin]

Gout=LUT[Gin]

Bout=LUT[Bin]

Namely, when a gradation of a pixel exceeds the maximum gradation luminance maxL, the gradation conversion unit 210 clips the gradation exceeding the maximum gradation luminance to the maximum gradation. Consequently, if the luminance error number threshold value ErrThld is set to a small value, the gradation of the bright region is maintained. On the other hand, if the luminance error number threshold value ErrThld is set to a large value, the hatched region as shown in FIG. 3 becomes larger. In this case, the gradation of the bright region is clipped, and consequently whiteout occurs to the gradation contained in the hatched region.

As described above, in the image processing apparatus in this embodiment, in the case that the control of the backlight brightness and the gradation conversion are performed based on the luminance histogram histoL obtained from each frame, the luminance histogram histoL is obtained by assigning the luminance of the pixels having the lower saturation of the color shade of the pixels in the frame with larger weighting coefficient W.

According to the image processing apparatus in this embodiment, by generating the luminance histogram histoL in which the larger weighting coefficient W is given to the luminance of the pixels with lower saturation rather than the pixels with higher saturation which is resistant to occur whitening due to the damage of gradations, the black floating is improved by lowering the backlight brightness in frames including many pixels with high saturation, and whitening due to whiteout is suppressed through suppressing the reduction of the backlight brightness in frames including many pixels with low saturation.

Also, in this embodiment, if the scene change detection unit 140 detects that the scene change has occurred, the weighting is performed so that the backlight brightness is re-examined. Accordingly, in comparison to the case in which the backlight brightness is controlled for each frame, the amount of computation can be reduced, and thus the power consumption can be reduced. In this case, if the backlight brightness is controlled for each frame without applying the scene change detection unit 140, the backlight brightness can be properly set in a scene in which the brightness is gradually changed.

The present invention is not limited to this embodiment, and in practice, the constituent elements may be modified and embodied without deviating from the scope of the invention. Also, by properly combining the constituent elements disclosed in the embodiments, various inventions can be formed. Also, for example, deletion of some constituent elements from the entire constituent elements disclosed in the embodiments may be considered. In addition, other constituent elements described in other embodiments may be properly combined.

What is claimed is:

1. An image processing apparatus comprising:
a saturation extraction unit which obtains saturation information from each pixel included in a frame;
a luminance extraction unit which obtains luminance information of the each pixel;
a histogram generation unit which generates histogram information corresponding to luminance information by summering weighting coefficient, wherein a larger weighting coefficient is assigned to a lower saturation;
a determining unit which determines the maximum luminance based on the histogram information and determines a brightness of a backlight based on a display ability of a display unit and the maximum brightness; and
a gradation conversion unit which converts a gradation of an input image based on the maximum luminance.

2. The apparatus according to claim 1, wherein the display ability is the maximum brightness of the display unit.

3. The apparatus according to claim 1, further comprising:
a scene change detection unit which detects whether a scene change has occurred by comparing frames contained in the input image,
wherein histogram generation unit generates the histogram information when the scene change detection unit detects the occurrence of a scene change.

4. The apparatus according to claim 1, wherein the luminance extraction unit extracts the luminance information based on a red value, a green value, and a blue value extracted from a pixel.

5. The apparatus according to claim 1, wherein the histogram information includes a plurality of level, and the histogram generation unit sums the weighting coefficients with the same level.

6. A image processing method, comprising:
obtaining saturation information from each pixel included in a frame;
obtaining luminance information of the each pixel;
generating histogram information corresponding to luminance information by summering weighting coefficient, wherein a larger weighting coefficient is assigned to a lower saturation;
determining the maximum luminance based on the histogram information;
determining a brightness of a backlight based on a display ability of a display unit and the maximum brightness; and
converting a gradation of an input image based on the maximum luminance.

7. The method according to claim 6, wherein the display ability is the maximum brightness of the display unit.

8. The method according to claim 6, further comprising:
detecting whether a scene change has occurred by comparing frames contained in the input image,
wherein the generating generates histogram information when the scene change detection unit detects the occurrence of a scene change.

9. The method according to claim 6, the extracting extracts the luminance information based on a red value, a green value, and a blue value extracted from a pixel.

10. The apparatus according to claim 6, wherein the histogram information includes a plurality of level, and the generating sums the weighting coefficients with the same level.
